(19) United States
(12) Patent Application Publication
(10) Pub. No.: US 2004/0224125 A1
(43) Pub. Date: Nov. 11, 2004

(54) Ceramic members, a method of producing the same and corrosion resistant members

(75) Inventors: Hirotake Yamada, Anjyo-city (JP); Kouichi Imao, Kagamigahara-city (JP); Tsutomu Naitou, Kasugai-city (JP)

Correspondence Address: BURR & BROWN, PO BOX 7068, SYRACUSE, NY, 13261-7068, US

(73) Assignee: NGK Insulators, Ltd., Nagoya-City (JP)

(21) Appl. No.: 10/837,888

(22) Filed: May 3, 2004

(30) Foreign Application Priority Data
May 8, 2003 (JP) P2003-129725
Jul. 25, 2003 (JP) P2003-201561

(51) Int. Cl. B32B 3/10

(52) U.S. Cl. 428/131

(57) ABSTRACT

An object of the present invention is to prevent particle generation from holes formed in a ceramic member. A ceramic member 2 has a hole 20A formed therein. The hole 20A has a diameter “d” in a range of 0.05 mm to 2 mm and a length “L” of 2 mm or more. The member 2 has an inner wall surface 1 facing the hole 20A and the inner wall surface comprises an as-sintered face.

This application claims the benefits of Japanese Patent Applications P2003-201, 561 filed on Jul. 25, 2003 and P2003-129, 725 filed on May 8, 2003, the entireties of which are incorporated by reference.

### BACKGROUND OF THE INVENTION

1. Field of the Invention

The present invention relates to a ceramic member with a hole formed therein.

2. Related Art Statement

In a field of a system for producing semiconductors, it has been known an article called a shower plate or gas distribution plate. The plate has a ceramic plate-molded substrate with many through holes formed therein. The gas distribution plate is mounted in a space over a semiconductor wafer, and a halogen gas is supplied into the space over the wafer through the through holes of the plate to generate plasma.

### SUMMARY OF THE INVENTION

In a conventional process of producing a gas distribution plate, a ceramic plate-molded substrate is ground to form many through holes therein. The grinding process may induce processing damage in the ceramic substrate to generate particles, leading to semiconductor defects. It is thus necessary to prevent the particle generation from the plate.

For example, when a gas distribution plate is produced, a disk-molded ceramic sintered body is produced and then processed to form through holes. The processing for forming the through holes after the sintering, however, results in processing damage on the inner wall surface facing the through holes. When a corrosive gas is passed through the holes, for example, particles generation may be problematic from the inner wall surface due to the processing damage.

An object of the present invention is to prevent particle generation from holes formed in a ceramic member.

Another object of the present invention is to provide a process of producing a ceramic member with a hole formed therein, so that the production cost is reduced and the dimensional precision of the hole is improved compared with a conventional process of forming a hole in a ceramic sintered body.

A first aspect of the present invention provides a ceramic member comprising a hole formed therein: wherein said hole has a diameter in a range of 0.1 mm to 2 mm and a length of 2 mm or more. The member comprises an inner wall surface facing the hole and the inner wall surface comprises an as-sintered face.

For example, a hole formed in a gas distribution plate has an elongate shape of a diameter of 2 mm or smaller and a length of 2 mm or more. When a halogen based corrosive gas is supplied through the hole onto a wafer, particles may be easily and considerably generated from the inner wall surface facing the hole. It is considered that the hole has a small diameter so that processing damage on the inner wall surface facing the hole may easily result in the generation of particles from the inner wall surface.

Contrary to this, according to the first aspect of the present invention, the inner wall surface facing the hole is made an as-fired face, when the hole has a diameter of 2 mm or smaller and a length of 2 mm or longer. It is thus possible to considerably reduce the particle generation from the inner wall surface facing the hole. It is proved that the advantageous effects are considerable when the hole has an elongate shape of a diameter of 2 mm or smaller and a length of 2 mm or longer. It may be considered as follows. That is, the particle generation due to damage on the inner wall surface is considerable when the hole has an elongate shape as described above.

An as-fired face means a face generated by a sintering process of a ceramic molded body and not subjected to mechanical processing. The inner wall surface facing the hole may be subjected to a surface removal process by means of a chemical after the sintering, according to the invention. Further, a film may be coated on the inner wall surface facing the hole of the ceramic member, according to the invention.

In an as-fired face of a ceramics, for example as shown in FIG. 8, each of ceramic particles has a surface shape approximating a partial sphere. On the other hand, a face after mechanical processing is partly flat and processing damages are observed, for example as shown in FIG. 9.

A second aspect of the present invention provides a corrosion resistant member comprising a main body made of a ceramics and having a hole formed therein and an innermost layer provided on the inner wall face of the main body and facing the hole. The innermost layer comprises an anti-corrosive ceramics and the hole has a diameter in a range of 0.1 mm to 2 mm and a length of 2 mm or more.

According to a second aspect of the present invention, the corrosion resistant ceramic layer facing the hole is provided, when the hole has a diameter of 2 mm or smaller and the length is 2 mm or longer. It is thus possible to considerably reduce the particle generation from the inner wall surface facing the hole. It is proved that the advantageous effects are considerable when the hole has an elongate shape of a diameter of 2 mm or smaller and a length of 2 mm or longer. It may be considered as follows. That is, the particle generation due to damage on the inner wall surface is most considerable when the hole has an elongate shape as described above.

A third aspect of the present invention provides a method of producing a ceramic member comprises a hole formed therein using a mold having an outer frame defining a shaping space and a protrusion protruding into the space. The method comprising the steps of; casting a slurry containing an inorganic sinterable powder, a dispersing medium and a gelling agent into said space; and solidifying the slurry by gelation to shape at lease a part of a molded body; and sintering the molded body to provide a ceramic member.

According to the method, it is possible to provide a specific ceramic layer onto the inner wall surface facing the hole without a specific processing. Moreover, a troublesome processing for forming many small holes, for example by grinding, may be omitted, leading to a higher productivity at a lower cost. As described above, a gel cast slurry is used to form the hole, so that the dimensional precision of the hole can be improved.

It is also considered a method to embed organic materials in a molded body, to sinter the molded body and thus to remove the organic materials so that holes are left. The inner wall surface facing the hole can be made an as-fired face also in this case. According to the method, however, it is necessary to embed the organic materials in the ceramic powder before the molded body is obtained. It is also considered a method to form holes in the molded body without the organic materials and then to embed organic material in the holes. According to the method, however, such processing of forming the holes in the molded body is troublesome. Moreover, powder and slurry constituting the molded body has liquidity and thus flowable. It is thus very difficult to accurately decide relative positions of the organic materials embedded in the molded body. Further, a trace amount of a metal component (ash) may be left in the molded body to result in a possibility of contamination of a wafer.

A fourth aspect of the present invention provides a method of producing a ceramic member comprising a main body having a hole formed therein and an innermost layer provided on the inner wall face of the member and facing the hole. A mold having an outer frame defining a shaping space and a protrusion protruding into the space is used. The method comprising the steps of; applying a first gel cast slurry generating the innermost layer upon sintering on the protrusion and to solidify the first gel cast slurry; casting a second gel cast slurry generating the main body upon sintering into the space to solidify the second gel cast slurry so that a molded body is obtained; and sintering the molded body to provide a ceramic member comprising the main body and innermost layer.

According to the fourth aspect of the present invention, a difference of a designed target dimension and a measured dimension can be considerably reduced in producing the above composite molded body. For example, when a two layered structure is formed having a corrosion resistant layer on the one side for protection against corrosion, it may be demanded to apply a design that a part of the corrosion resistant layer is larger in thickness. Even when such design having the layer whose thickness is partly changed, a molded body can be obtained while the actual measured dimension is very close to a designed dimension according to the fourth aspect of the present invention.

These and other objects, features and advantages of the invention will be appreciated upon reading the following description of the invention when taken in conjunction with the attached drawings, with the understanding that some modifications, variations and changes of the same could be made by the skilled person in the art.

### BRIEF DESCRIPTION OF THE DRAWINGS

FIG. 1(a) is a cross sectional view schematically showing a mold 15 for molding a ceramic member according to the present invention,

FIG. 1(b) is a cross sectional view showing a mold 15 and a gel casting slurry 17 cast into the mold 15,

FIG. 1(c) is a cross sectional view schematically showing a ceramic member 2.

FIG. 2 shows an example of a flow chart showing a manufacturing process according to the third aspect of the present invention,

FIG. 3(a) is a cross sectional view schematically showing a mold 15 for shaping a molded body according to the present invention.

FIG. 3(b) is a cross sectional view showing a mold 15 whose molding space 16 is filled with a gel cast molding slurry 17.

FIG. 3(c) is a cross sectional view showing a mold 15 in which a gel cast slurry 19 is further cast.

FIG. 3(d) is a cross sectional view schematically showing a ceramic member 4.

FIG. 4 shows an example of a flow chart showing a manufacturing process according to the third aspect of the present invention,

FIG. 5(a) is a cross sectional view schematically showing a mold 15.

FIG. 5(b) is a cross sectional view showing a mold 15 whose molding space 16 is filled with a gel cast molding slurry 17 for a surface layer.

FIG. 5(c) is a cross sectional view showing a mold 15 in which a gel cast slurry 19 is applied to protrusions 15b in a molding space 16.

FIG. 5(d) is a cross sectional view schematically showing a mold in which a gel cast slurry for a main body is cast in a molding space.

FIG. 6(a) is a cross sectional view schematically showing a sintered body 24 obtained by sintering a molded body of FIG. 5(d).

FIG. 6(b) is a cross sectional view schematically showing a sintered body 24A obtained by forming through holes 20 in a sintered body 24 shown in FIG. 6(a).

FIG. 7 is a flow chart showing a manufacturing process in an Experiment “A”.

FIG. 8 shows a photograph of an inner wall surface facing a hole taken by a scanning electron microscope in a ceramic member according to the present invention.

FIG. 9 shows a photograph of an inner wall surface facing a hole taken by a scanning electron microscope in a ceramic member according to a comparative example.

### PREFERRED EMBODIMENTS OF THE INVENTION

In the first to fourth aspects of the present invention, the diameter of the hole may preferably be 1 mm or smaller, on the viewpoint of the above effects of the present invention. Further, the length of the hole may preferably be 2.4 mm or longer.

Holes are formed in the ceramic member according to the present invention. Although the number of the holes is not limited, the advantageous effects of the third and fourth aspects of the present invention on the production cost is considerable as the number of the holes is large, particularly 10 or more.

According to the first and third aspects of the present invention, a plurality of ceramic phases may be generated in the ceramic member. The whole of the ceramic member may be made of a single ceramic phase or preferably of a plurality of ceramic phases. The ceramic phases may be made of different ceramic materials to utilize the characteristics of the ceramic materials. For example, a ceramics having a higher strength may be used for a substrate and a ceramics having superior corrosion resistance may be formed on a face of the substrate exposed to a corrosive gas.

In this case, a composite sintered body may be sintered so that a plurality of ceramic phases are co-sintered. It is thus possible to lower the number of sintering steps needed for producing the member, to improve the productivity of the composite sintered body, and to improve the dimensional precision of the thus obtained sintered body. Further, the materials for ceramic phases, porosity, kind and construction of crystal and properties such as thermal expansion or the like can be independently controlled depending on the manufacturing conditions of slurry.

The diameter of the hole may be 0.05 mm or larger. A hole having a diameter of 0.05 mm or smaller may be disappeared due to small differences of shrinkage in different directions during drying and sintering steps. It is thus difficult to obtain through holes after the sintering.

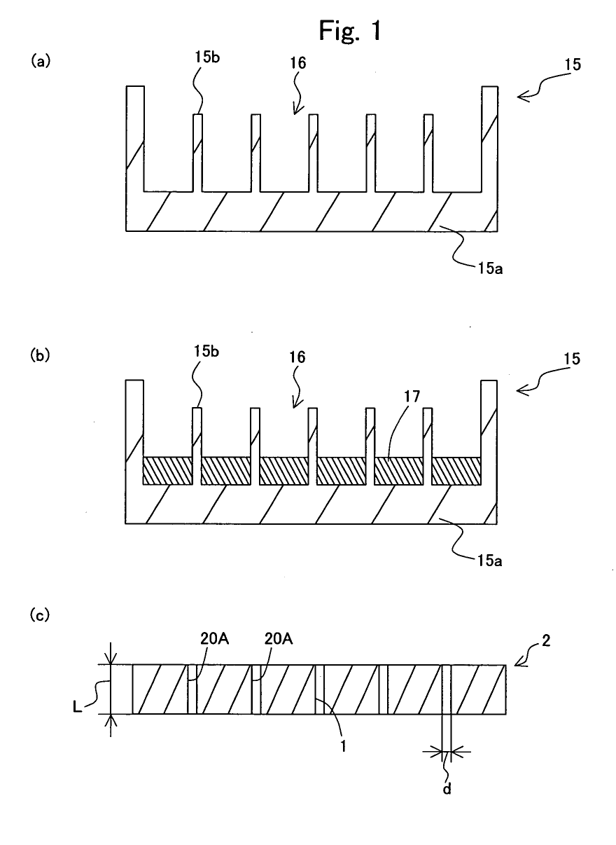

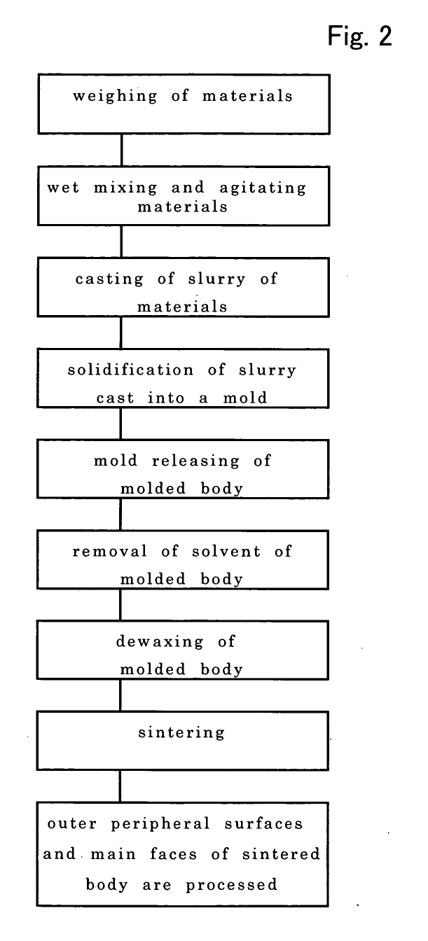

FIGS. 1(a), (b) and (c) are cross sectional views schematically showing steps in a manufacturing process according to the first and third aspects of the present invention. FIG. 2 is a flow chart showing a manufacturing process according to the present example.

According to the present example, ceramic raw materials are mixed, agitated and cast into a mold. A mold 15 shown in FIG. 1(a) is prepared. The mold 15 has an outer frame 15a and a predetermined number of pins 15b. The pins 15b are protruded into a molding space 16. Preferably, a ceramic gel cast molding material 17 is supplied at a predetermined height in the mold. The material 17 is solidified to obtain a molded body, which is then removed from the mold. The solvent in the molded body is then removed. The conditions such as the composition of the materials, concentration and manufacturing process will be described later.

The molded body is then dewaxed and sintered to obtain a ceramic member 2 shown in FIG. 1(c). The ceramic member 2 is disk-shaped. A predetermined number of holes 20A, such as through holes, are formed in the member 2. “d” represents a diameter of each hole 20A and “L” represents a length of each hole 20A.

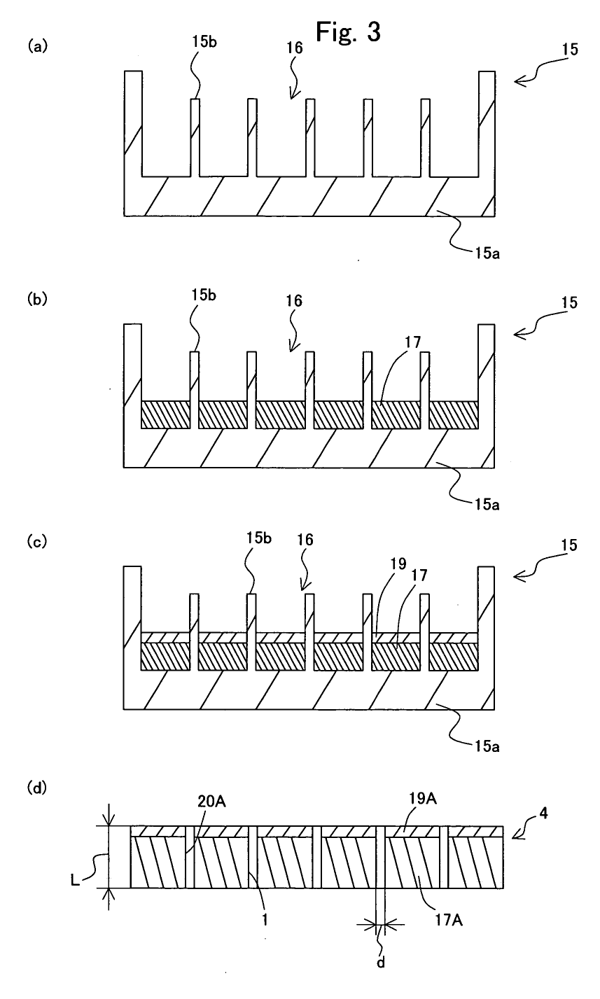

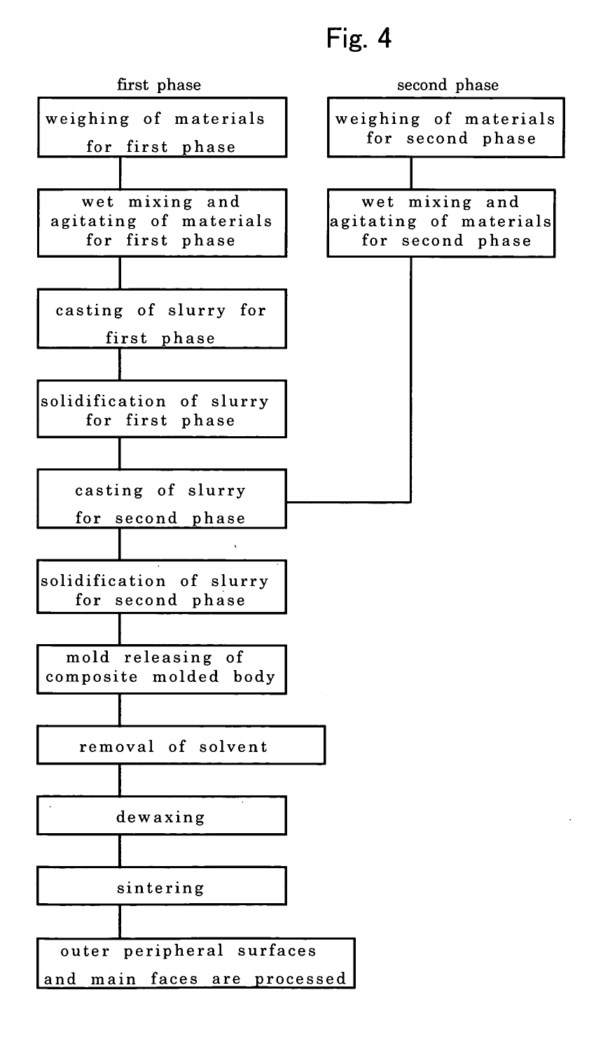

FIGS. 3(a) to (d) are cross sectional views schematically showing steps in a manufacturing process according to the first and third aspects of the present invention. FIG. 4 is a flow chart showing a manufacturing process according to the present example.

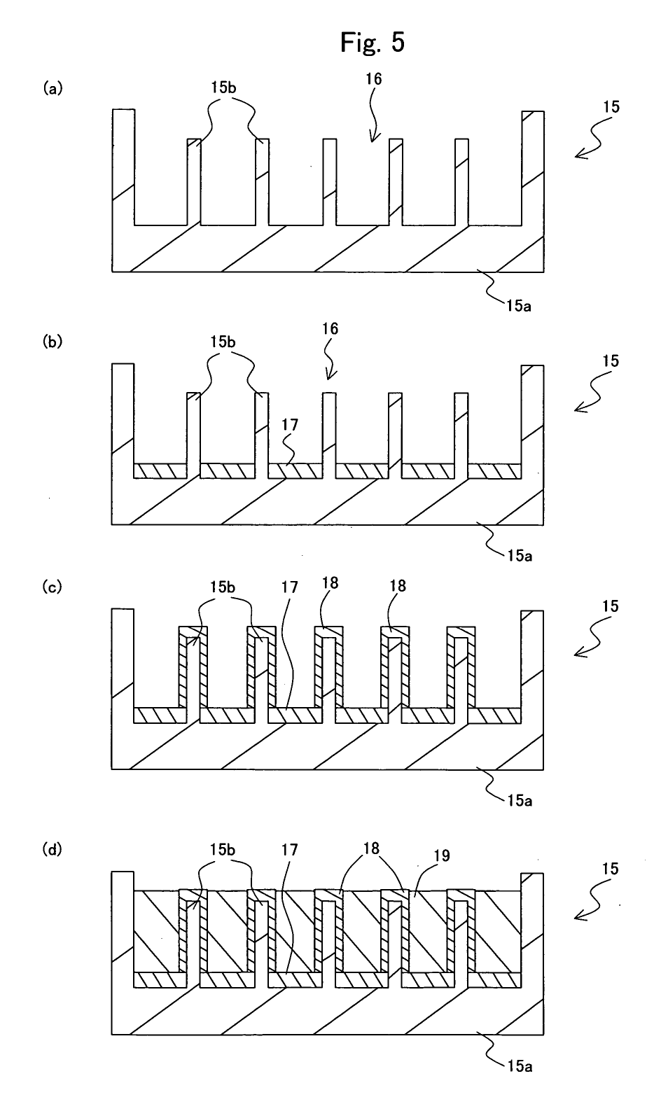

According to the present example, ceramic raw materials for a first phase is weighed, mixed, agitated and cast into a mold. A mold 15 shown in FIG. 3(a) is prepared. The mold 15 has an outer frame 15a and a predetermined number of pins 15b. The pins 15b are protruded into a molding space 16. A ceramic gel cast molding material (for a first phase) 17 is supplied at a predetermined height in the mold (FIG. 5(b)).

On the other hand, a gel cast molding material for a second phase is supplied into a molding space 16 in the mold 15 to generate a second phase 19 shown in FIG. 3(c). The second phases is solidified and the thus obtained molded body is removed from the mold. A solvent in the molded body is then removed.

The molded body is then dewaxed and sintered to obtain a ceramic member 4 shown in FIG. 3(d). The ceramic member 4 has a main body 17A and surface layer 19A.

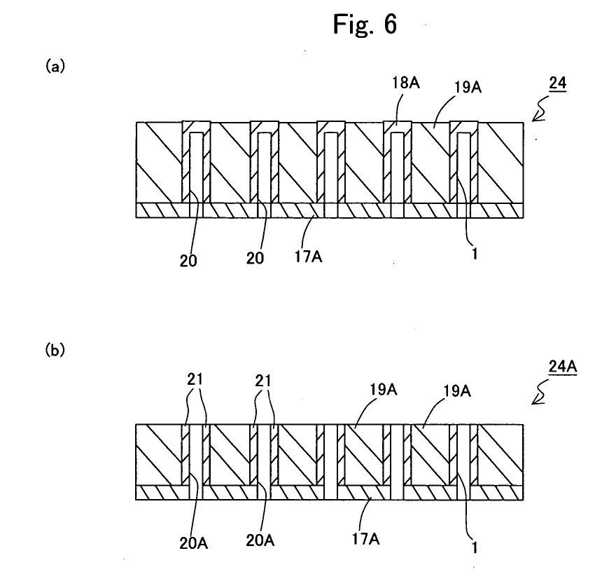

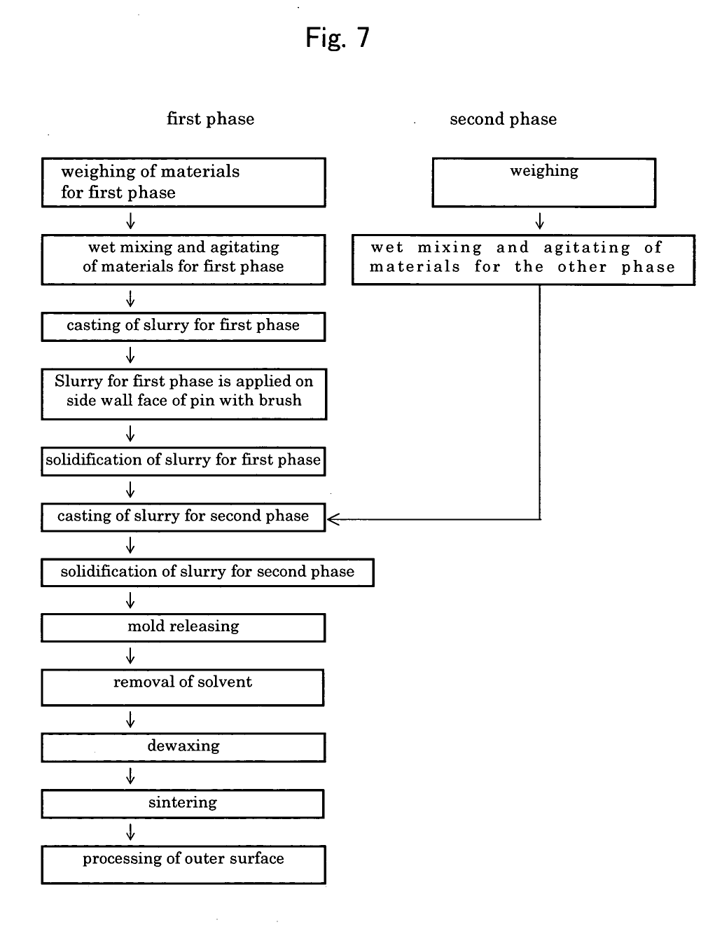

FIGS. 5 and 6 are cross sectional views schematically showing steps in a manufacturing process according to the second and fourth aspects of the present invention. FIG. 7 is a flow chart showing a manufacturing process according to the present example.

According to the present embodiment, raw materials for an innermost layer is weighed, mixed, agitated and cast into a mold. On the other hand, a mold 15 shown in FIG. 5(a) is prepared. The mold 15 has an outer frame 15a and a predetermined number of pins 15b. The pins 15b are protruded into a space for molding 16. Preferably, a gel cast molding material 17 of ceramic is supplied at a predetermined height in the mold (see FIG. 5(b)).

The gel cast molding material for the first phase is applied onto the outer surfaces of the protrusions 15b to form adhered layers 18 shown in FIG. 5(c). The adhered layers 18 may be formed by any processes. Preferably, an applicator such as a brush is used to apply the gel cast molding material onto the surfaces of the pins. The material may be applied once or twice or more. It is possible to increase the thickness of the adhered and innermost layers by increasing the number of repetition of the application process. The shape of the protrusion is not particularly limited, as long as the hole may be molded.

On the other hand, the gel cast molding material for the main body is supplied into the molding space 16 of the mold 15 to form the main body shown in FIG. 5(d). The main body is then solidified to obtain a molded body, which is then removed from the mold. A solvent in the molded body is then removed.

The molded body is then dewaxed and sintered to obtain a sintered body 24 shown in FIG. 6(a). The sintered body 24 has a main body 19A, a predetermined number of innermost layers 18A formed in the main body 19A and a surface layer 17A. The sealing portions of the holes 20 in the sintered body 24 are removed by surface grinding to obtain a sintered article 24A shown in FIG. 6(b). The sintered body 24A has the main body 19A, many small holes 20A passing through the main body 19A, innermost layers 21 facing the holes 20A and a surface layer 17A.

According to the first to fourth aspects of the present invention, materials for the ceramic phases are not particularly limited, and may preferably be the followings.

Oxide series ceramics such as alumina, zirconia, titania, silica, magnesia, ferrite, cordielite and oxides of rare elements such as yttria;

Composite oxides such as barium titanate, strontium titanate, lead zirconate titanate, manganites of rare earth elements and chromites of rare earth elements;

Nitride series ceramics such as aluminum nitride, silicon nitride and sialon;

Carbide series ceramics such as silicon carbide, boron carbide, and tungsten carbide;

Fluoride series ceramics such as beryllium fluoride, magnesium fluoride, calcium fluoride, strontium fluoride, barium fluoride and so on.

When the ceramic member has a plurality of ceramic phases, one of the phases may be made of a ceramics containing alumina, and the other may be made of a ceramics containing an yttria-alumina composite oxide.

In the ceramics containing an yttria-alumina composite oxide, the composite oxide includes the followings.

Y₃Al₅O₁₂ (YAG: 3Y₂O₃.5Al₂O₃) (1)

This contains yttria and alumina in a ratio of 3:5, and has garnet crystal structure.

YAlO₃ (YAL: Y₂O₃.Al₂O₃) (2)

This has perovskite crystal structure.

Y₄Al₂O₉ (YAM: 2Y₂O₃.Al₂O₃) (3)

This belongs to monoclinic system.

In the embodiment, additional components and impurities other than the yttria-alumina composite oxide are not excluded. However, a total content of the components other than the composite oxide may preferably be 10% by weight or less.

Furthermore, in the above ceramics containing alumina, the yttria-alumina composite oxide described above, a spinel type compound, a zirconium compound and a rare earth compound may be contained. In this embodiment, if the total content of the yttria-alumina composite oxide, spinel type compound, zirconium compound and rare earth compound is too large, the thermal conductivity and the material strength may be lowered. Accordingly, the content is preferable to be 50% by weight or less in total, being further preferable to be in the range of 3 to 35% by weight.

In both of the ceramics containing alumina and yttria-alumina composite oxide, the powder mixture may contain powder of a third component. However, the third component is preferable not to be detrimental to the garnet phase and is preferable to be capable of replacing yttria or alumina in the garnet phase. As such components, the followings may be listed.

La₂O₃, Pr₂O₃, Nd₂O₃, Sm₂O₃, Eu₂O₃, Gd₂O₃, Tb₂O₃, Dy₂O₃, Ho₂O₃, Er₂O₃, Tm₂O₃, Yb₂O₃, Lu₂O₃, MgO, CaO, SrO, ZrO₂, CeO₂, SiO₂, Fe₂O₃, and B₂O₃.

According to the present invention, at least a part of the ceramic member is molded with a gel cast molding process.

According to the process, a slurry containing a powder of a ceramics or metal, a dispersing medium and gelling agent are molded and gelled with the addition of a crossing agent or adjustment of temperature so that the slurry is solidified to obtain a molded body.

A gel cast molding process is known as a process for producing a molded body of powder. However, it has not known to shape the first phase with gel cast molding in producing the molded body having the first and second phases. It has not also known to co-fire the thus obtained composite molded body to produce a composite sintered body having ceramic phases.

Gel cast molding process may be carried out as follows.

(1) A gelling agent and inorganic powder are dispersed in a dispersing agent to produce a slurry. The gelling agent may be polyvinyl alcohol and a prepolymer such as an epoxy resin and phenol resin. The slurry is then supplied into a mold and subjected to three dimensional cross linking reaction with a cross linking agent to solidify the slurry.

(2) An organic dispersing medium having a reactive functional group and a gelling agent are chemically bonded with each other to solidify the slurry. The process is described in Japanese patent publication 2001-335371A (US publication 2002-0033565).

According to the process, it is preferred to use an organic dispersing medium having two or more reactive functional groups. Further, 60 weight percent or more of the whole dispersing medium may preferably be an organic dispersing medium having a reactive functional group.

The organic dispersing medium having a reactive functional group may preferably have a viscosity of 20 cps or lower at 20° C. The gelling agent may preferably have a viscosity of 3000 cps or lower at 20° C. Specifically, it is preferred to react the organic dispersing medium having two or more ester bonds with the gelling agent having an isocyanate group and/or an isothiocyanate group to solidify the slurry.

An organic dispersing medium satisfies the following two conditions.

(1) The medium is a liquid substance capable of chemically reacting with the gelling agent to solidify the slurry.

(2) The medium is capable of producing the slurry with a high liquidity for the ease of supply into the mold.

The organic dispersing medium necessarily has a reactive functional group, such as hydroxyl, carboxyl and amino groups capable of reacting with the gelling agent in the molecule for solidifying the slurry.

The organic dispersing medium has at least one reactive functional group. The organic dispersing medium may preferably have two or more reactive functional groups for accelerating the solidification of the slurry.

The liquid substance having two or more reactive functional groups includes a polyalcohol (ex. a diol such as ethylene glycol, a triol such as glycerin or the like) and polybasic acid (dicarboxylic acid or the like).

It is not necessary that the reactive functional groups in the molecule may be the same or different kind of functional groups with each other. Further, many reactive functional groups may be present such as polyethylene glycol.

On the other hand, for producing a slurry with a high liquidity for the ease of casting, it is preferred to use a liquid substance having a viscosity as low as possible. The substance may preferably have a viscosity of 20 cps or lower at 20° C.

The above polyalcohol and polybasic acid may have a high viscosity due to the formation of hydrogen bonds. In this case, even when the polyalcohl or polybasic acid is capable of solidifying the slurry, they are not suitable as the reactive dispersing medium. In this case, it is preferred to use, as the organic dispersing medium, an ester having two or more ester bonds such as a polybasic ester (for example, dimethyl glutarate), or acid ester of a polyalcohol (such as triacetin).

Although an ester is relatively stable, it has a low viscosity and may easily react with the gelling agent having a high reactivity. Such ester may satisfy the above two conditions. Particularly, an ester having 20 or lower numbers of carbon atoms has a low viscosity, and may be suitably used as the reactive dispersing medium.

In the embodiment, a non-reactive dispersing medium may be also used. The dispersing agent may preferably be an ether, hydrocarbon, toluene or the like.

Further, when an organic substance is used as the non-reactive dispersing agent, preferably 60 weight percent or more, more preferably 85 weight percent or more of the whole dispersing agent may be occupied by the reactive dispersing agent for assuring the reaction efficiency with the gelling agent.

The reactive gelling agent is described in Japanese patent publication 2001-335371A (US publication 2002-0033565).

Specifically, the reactive gelling agent is a substance capable of reacting with the dispersing medium to solidify the slurry. The gelling agent of the present invention may be any substances, as long as it has a reactive functional group which may be chemically reacted with the dispersing medium. The gelling agent may be a monomer, an oligomer, or a prepolymer capable of cross linking three-dimensionally upon the addition of a cross linking agent such as polyvinyl alcohol, an epoxy resin, phenol resin or the like.

The reactive gelling agent may preferably have a low viscosity, fo example, of not larger than 3000 cps at 20° C., for assuring the liquidity of the slurry.

A prepolymer and polymer having a large average molecular weight generally have a high viscosity. According to the present invention, a monomer or oligomer having a lower molecular weight, such as an average molecular weight (GPC method) of not larger than 2000, may be preferably used.

Further, the “viscosity” means a viscosity of the gelling agent itself (viscosity of 100 percent gelling agent) and does not mean the viscosity of a commercial solution containing a gelling agent (for example, viscosity of an aqueous solution of a gelling agent).

The reactive functional group of the gelling agent of the present invention may be selected considering the reactivity with the reactive dispersing medium. For example, when an ester having a relatively low reactivity is used as the reactive dispersing medium, the gelling agent having a highly reactive functional group such as an isocyanate group (—N═C═O) and/or an isothiocyanate group (—N═C═S) may be preferably used.

An isocyanate group is generally reacted with an diol or diamine. A diol generally has, however, a high viscosity as described above. A diamine is highly reactive so that the slurry may be solidified before the supply into the mold.

Taking such a matter into consideration, a slurry is preferable to be solidified by reaction of a reactive dispersion medium having ester bonds and a gelling agent having an isocyanate group and/or an isothiocyanate group. In order to obtain a further sufficient solidified state, a slurry is more preferable to be solidified by reaction of a reactive dispersion medium having two or more ester bonds and a gelling agent having isocyanate group and/or an isothiocyanate group.

Examples of the gelling agent having isocyanate group and/or isothiocyanate group are MDI (4,4′-diphenylmethane diisocyanate) type isocyanate (resin), HDI (hexamethylene diisocyanate) type isocyanate (resin), TDI (tolylene diisocyanate) type isocyanate (resin), IPDI (isophorone diisocyanate) type isocyanate (resin), and an isothiocyanate (resin).

Additionally, in the present invention, other functional groups may preferably be introduced into the foregoing basic chemical structures while taking the chemical characteristics such as compatibility with the reactive dispersion medium and the like into consideration. For example, in the case of reaction with a reactive dispersion medium having ester bonds, it is preferable to introduce a hydrophilic functional group from a viewpoint of improvement of homogeneity at the time of mixing by increasing the compatibility with esters.

Further, in the present invention, reactive functional groups other than isocyanate and isothiocyanate groups may be introduced into a molecule, and isocyanate group and isothiocyanate group may coexist. Furthermore, as a polyisocyanate, a large number of reactive functional groups may exist together.

The slurry for shaping the first or second phase may be produced as follows.

(1) The inorganic powder is dispersed into the dispersing medium to produce the slurry, into which the gelling agent is added.

(2) The inorganic powder and gelling agent are added to the dispersing agent at the same time.

The slurry may preferably have a viscosity at 20° C. of 30000 cps or less, more preferably 20000 cps or less, for improving the workability when the slurry is filled into a mold. The viscosity of the slurry may be adjusted by controlling the viscosities of the aforementioned reactive dispersing medium and gelling agent, the kind of the powder, amount of the dispersing agent and content of the slurry (weight percent of the powder based on the whole volume of the slurry).

If the content of the slurry is too low, however, the density of the molded body is reduced, leading to a reduction of the strength of the molded body, crack formation during the drying and sintering processes and deformation due to an increase of the shrinkage. Normally, the content of the slurry may preferably be in a range of 25 to 75 volume percent, and more preferably be in a range of 35 to 75 volume percent, for reducing cracks due to the shrinkage during a drying process.

Further, various additives may be added to the slurry for shaping. Such additives include a catalyst for accelerating the reaction of the dispersing medium and gelling agent, a dispersing agent for facilitating the production of the slurry, an anti-foaming agent, a detergent, and a sintering aid for improving the properties of the sintering body.

When the ceramic member has a plurality of ceramic phases, phases other than the first phase may be molded by any processes, including gel cast molding described above, cold isostatic pressing, slip casting, slurry dipping, doctor blade and injection molding. The order of shaping steps of the first and second phases is not limited. For example, the first phase is molded by gel cast molding and the second phase may be then molded by gel cast molding or the other process to produce a composite molded body. Alternatively, the second phase is molded by gel cast molding or the other process to produce a molded body, which may be then contained in a mold and the first phase may be then molded by gel cast molding in the same mold.

In the second and fourth aspects of the present invention, the innermost layer comprises a corrosive ceramics including an oxide series ceramics including alumina, zirconia, titania, silica, magnesia, ferrite, cordielite and oxides of rare elements such as yttria; composite oxides such as barium titanate, strontium titanate, lead zirconate titanate, manganites of rare earth elements and chromites of rare earth elements; nitride series ceramics such as aluminum nitride, silicon nitride and sialon; carbide series ceramics such as silicon carbide, boron carbide, and tungsten carbide; and fluoride series ceramics such as beryllium fluoride, magnesium fluoride, calcium fluoride, strontium fluoride, barium fluoride and so on. The ceramics may most preferably be the yttria-alumina composite oxide described above.

Further, in a preferred embodiment of the second and fourth aspects, the thickness of the innermost layer is 1 μm or larger, so as to further reduce the particle generation from the inner wall surface facing the hole. On the viewpoint, the thickness of the innermost layer may preferably be 50 μm or larger. It is more advantageous to form the innermost layer by gel cast molding by adjusting the thickness of the innermost layer to 2 mm or smaller.

In a preferred embodiment, the innermost layer comprises an yttrium-aluminum garnet, and the corrosion resistant member has a portion adjacent to the innermost layer. The adjacent portion contains alumina in an amount of not lower than 50 weight percent. In this embodiment, the adjacent portion may contain the above yttria-alumina composite oxide, a spinel compound, a zirconium compound or a rare earth compound other than alumina.

In the invention, the precisions of the molded and sintered bodies mean differences between the respective designed dimensions and the dimensions of the actually obtained molded and sintered bodies. This includes the following two cases.

(1) A Difference Between the Designed Dimension and an Average Value of Dimension of Actually Produced Articles in Each of the Molded and Sintered Bodies

That is, the measured values of dimensions may be deviated upon measured positions in each of the actually obtained molded and sintered bodies. As the difference between the designed value and the average of actually measured values is smaller, the dimensional precision is better.

According to the invention, the holes are molded with gel cast molding. It is thus possible to reduce differences between the designed values and measured values (averages) of the dimension of the holes in the molded and sintered bodies.

(2) Deviation of Dimensions in the Molded Body Actually Produced

The measured value of the dimension may be deviated upon positions in each of the molded and sintered bodies. As the deviation of the measured values is smaller, the dimensional precision is higher. It is possible to reduce the deviation of the measured value of the dimension of the hole, by shaping the first phase by gel cast molding.

In a preferred embodiment, the difference of the thermal expansion coefficients of a plurality of ceramic phases at 1500° C. is 0.5 ppm/° C. or lower. It is thus possible to effectively prevent crack formation and peeling in the sintered body, leading to the improvement of the production yield.

The thus obtained molded body is then sintered to produce the sintered body of the present invention. The sintering temperature, atmosphere, temperature ascending and descending rates, and a holding time period at the maximum temperature is to be decided depending on the materials constituting the ceramic member. Generally, the maximum temperature during the sintering may preferably be in a range of 1300 to 2000° C. Further, when the ceramics containing an yttria-alumina composite oxide is to be sintered, the maximum temperature may preferably be in a range of 1400 to 1700° C.

### EXAMPLES

(Experiment “A” According to the First, Second, Third and Fourth Aspects of the Present Invention)

The sintered body 24A shown in FIG. 6(b) was produced. In the present example, the alumina substrate 19A with added zirconia and the innermost layer 21 made of YAG (yttrium-aluminum garnet) were continuously produced with gel cast molding, according to a flow chart shown in FIG. 7.

(Production of Raw Materials for Innermost Layer)

100 weight parts of yttrium-aluminum garnet powder, 7 weight parts of an aliphatic polyisocyanate, 25 weight parts of an organic polybasic ester, 5 weight parts of triethyl amine and 0.5 weight parts of poly maleic acid were mixed and dispersed in a pot mill to obtain a slurry for the YAG film.

(Production of Materials for Main Body)

Specifically, 100 weight parts of zirconia-added alumina powder, 7 weight parts of an aliphatic polyisocyanate (gelling agent), 25 weight parts of an organic polybasic acid ester, 5 weight parts of triethyl amine and 0.5 weight parts of polymaleic acid copolymer were mixed in a pot mill. A slurry for the alumina main body 19 was thus obtained.

(Production of a Molded Body)

121 pins 15b were provided on the bottom face of a metal mold having an outer diameter φ of 480 mm and a height of 5 mm in intervals of 30 mm vertically and horizontally. Each pin 15b had a dimension adjusted for providing a small hole having a predetermined diameter after the sintering process. The gel cast slurry for YAG (for the first phase) was flown into the mold to a height so that the thickness becomes a predetermined value after the sintering process (17 shown in FIG. 5(b): the viscosity was 6 poise measured by a viscometer). After that, the remaining slurry for YAG was applied on the side face of each pin 15b with a brush. Each assembly was left for a time period between 20 minutes to 1 hour. Although the viscosity of the slurry can not be measured with a viscometer, the viscosity was near that of a paste. The viscosity was also considerably increased as time passes by. The assembly was then solidified in air for 2 hours. Alternatively, in the samples of the comparative examples, the slurry was not applied with a brush onto the surface of each pin.

After the slurry 19 for the second phase (main body) was prepared and left for 30 minutes, the slurry was then flown into the mold to a height so that a predetermined thickness was obtained after the sintering process. The slurry was then solidified for about 2 hours. The molded portion 19 for the alumina main body 19A was thus produced. The thus obtained molded body was removed from the metal mold 15 and dried in air for one day.

The thus obtained composite sintered body was removed from the mold, heat treated at 250° C. for 5 hours to remove the solvent, dewaxed at 1000° C. for 2 hours, and sintered at 1600° C. for 6 hours. The composite sintered body 24 was thus obtained.

The main body 19A had a diameter of 400 mm and composed of alumina containing 25 weight percent of 8 mol percent Y₂O₃ stabilized zirconia. The YAG layer 17A had a diameter of 400 mm. 121 open through holes 20A were formed each having a specific diameter. The holes are arranged two dimensionally in 11 rows and 11 lines in intervals of 25 mm in a plate face.

(Measurement of Particles)

Each of the sintered bodies of the inventive and comparative examples was set in a system for testing corrosion with the YAG film 17A orientating downwardly. A spacer with a diameter of 10 mm and an 8-inch Si wafer were set under the sintered body in this order. Cl₂ gas was supplied to a space over the wafer through the holes 20A from the side of alumina containing zirconia. The flow rate of Cl₂ gas was 300 sccm and the flow rate of the carrier gas (argon gas) was 100 sccm. The pressure of the gas was 0.1 torr. RF of 800 W was supplied. The wafer was held for 10 minutes. “SP-1” supplied by Tencor Inc. was used to count the number of particles on the wafer. The results were shown in table 1.

TABLE 1

| | | | | | | | | | maximum |
|---|---|---|---|---|---|---|---|---|---|
| | | | | | | | | | amount of |
| | dimension of small | | | | | | thickness of | incidence of | tipping/ |
| Experi- | hole | | first layer | | | | YAG on inner | particles | minimum |
| Mental | diameter | length | | film | second layer | | wall surface of | (counts/8 inch | amount of |
| No. | mm | mm | material | thickness | material | Thickness | small hole | wafer) | tipping |
| 1 | 0.5 | 3 | YAG | 1 mm | YSZ + | 2 mm | 0.5 mm | 60 | 1.2 |
| | | | | | alumina | | | | |
| 2 | 0.5 | 3 | YAG | 1 mm | YSZ + | 2 mm | 0 mm | 1500 | 1.3 |
| | | | | | alumina | | | | |
| 3 | 1 | 3 | YAG | 1 mm | YSZ + | 2 mm | 0.5 mm | 85 | 1.2 |
| | | | | | alumina | | | | |
| 4 | 2 | 3 | YAG | 1 mm | YSZ + | 2 mm | 0.5 mm | 105 | 1.4 |
| | | | | | alumina | | | | |
| 5 | 2.5 | 3 | YAG | 1 mm | YSZ + | 2 mm | 0.5 mm | 750 | 2.0 |
| | | | | | alumina | | | | |
| 6 | 0.5 | 2.4 | YAG | 1 mm | YSZ + | 1.4 mm | 0.5 mm | 75 | 1.4 |
| | | | | | alumina | | | | |
| 7 | 0.5 | 2 | YAG | 1 mm | YSZ + | 1 mm | 0.5 mm | 150 | 1.6 |
| | | | | | alumina | | | | |
| 8 | 0.5 | 1.5 | YAG | 1 mm | YSZ + | 0.5 mm | 0.5 mm | 250 | 2.0 |
| | | | | | alumina | | | | |
| 9 | 0.5 | 3 | YAG | 1 mm | YSZ + | 2 mm | 0.05 mm | 70 | 1.4 |
| | | | | | alumina | | | | |
| 10 | 0.5 | 3 | YAG | 1 mm | YSZ + | 2 mm | 0.001 mm | 240 | 1.5 |
| | | | | | alumina | | | | |
| 11 | 0.5 | 3 | YAG | 1 mm | YSZ + | 2 mm | 0.0005 mm | 1050 | 1.5 |
| | | | | | alumina | | | | |

In the test number 1 of the present invention, the number of particles was reduced to 60. In the test number 2 of comparative example, a YAG film was not formed on the inner wall surface facing the hole and a large number of particles were counted. In the test numbers 3, 4, 6, 7, 9 and 10, the number of particles was reduced. In the test number 5 of comparative example, the diameter of the hole was enlarged, and the number of particles was considerably increased as well as etching ratio. In the test number 8 of comparative example, the hole is shorter, and the number of particles and etching ratio were large. It is considered that when the hole is too narrow, the gas flow in the hole tends to be turbulent flow, leading to particle generation. In the test number 11, the YAG layer on the inner wall surface facing the hole is too thin and the number of particles was large.

(Measurement of an Amount of Tipping)

Each wafer was masked using a mask of a width of 5 mm arranged radially. A surface roughness tester “Form Talysurf 2 S4” (supplied by Taylor Hobson Inc.) was used to measure the steps formed on the peripheral part of each mask on five points from the center to the periphery of the wafer in an interval of 20 mm(center, 20 mm, 40 mm, 60 mm, 80 mm). The difference between the maximum and minimum values of the heights of the steps were calculated. When the diameter of the hole is too large, uniform etching proved to be difficult. When the diameter of the hole is too small, uniform etching tends to be difficult.

After the measurement of the particles, each sample 24A was cut along a line passing through the hole 20A in the direction of the length. Consequently, the YAG film 21 having a thickness of about 0.5 mm was formed on the inner wall surface facing the hole in the test number 1, in which the YAG slurry was applied onto the pins 15b with a brush. On the other hand, such YAG layer 21 was not observed on the inner wall surface facing the hole of the sample of the test number 2.

(Experiment “B” According to the First and Third Aspects of the Present Invention)

Samples 1 to 14 shown in table 2 were produced.

(Production of Samples 1 to 6)

A ceramic member 2 shown in FIG. 1(c) was mechanically processed to form holes 20A to provide the samples 1 to 6. Specifically, the disk-shaped sintered body 2 has a diameter φ of 400 mm and a thickness “L” of 2 mm. The samples 1 to 6 were made of materials shown in table 2.

Through holes (Air vent holes) 20A each having a predetermined diameter were formed two dimensionally in 11 rows and 11 lines in intervals of 25 mm in a plate face. The air vent hole 20A had a diameter “d” of 0.5 mm and formed by drilling.

(Production of Samples 7 to 12)

Samples 7 to 12 (refer to a numeral “2” in FIG. 2(c)) were produced according to the process shown in FIG. 2.

(Production of Raw Materials)

In the sample 7, 100 weight parts of alumina powder, 7 weight parts of an aliphatic polyisocyanate, 25 weight parts of an organic polybasic ester, 5 weight parts of triethyl amine and 0.5 weight parts of poly maleic acid were mixed and dispersed in a pot mill to obtain a slurry.

In the samples 8, 9, 10, 11 and 12, the alumina powder used for the sample 7 was substituted with YAG (yttrium-aluminum garnet) powder, YSZ (yttria stabilized zirconia) powder, AlN powder, silicon nitride powder and silicon carbide powder, respectively.

(Production of Molded Body)

121 pins 15b were provided on the bottom face of a metal mold having an outer diameter φ of 480 mm and a height of 5 mm in intervals of 30 mm vertically and horizontally. Each pin had a dimension adjusted for providing a small hole having a predetermined diameter after the sintering process. The gel cast slurry for YAG (for the first phase) was flown into the mold so that the thickness is made 4 mm after the sintering (17 shown in FIG. 1(b): the viscosity was 6 poise measured by a viscometer). The gel was solidified for about 2 hours.

The thus obtained molded body was removed from the metal mold 15 and dried in air for one day. The thus obtained molded body was removed from the mold, heat treated at 250° C. for 5 hours to remove the solvent, dewaxed at 1000° C. for 2 hours, and sintered at 1600° C. for 6 hours to obtain a ceramic member 2. The hole 20A had a diameter φ of 0.5 mm.

(Production of Samples 13 and 14)

Samples 13 and 14 (refer to “4” in FIG. 3(d)) shown in table 2 were produced according to the process shown in FIG. 4.

(Production of Lower Layer)

In the sample 13, 100 weight parts of alumina powder, 7 weight parts of an aliphatic polyisocyanate, 25 weight parts of an organic polybasic ester, 5 weight parts of triethyl amine and 0.5 weight parts of poly maleic acid were mixed and dispersed in a pot mill to obtain a slurry. In the sample 14, the alumina powder used for the sample 13 was substituted with a mixture of alumina powder with and without added zirconia.

(Production of Upper Layer)

In the samples 13 and 14, 100 weight parts of yttria-aluminum garnet powder, 7 weight parts of an aliphatic polyisocyanate (gelling agent), 25 weight parts of an organic polybasic ester, 5 weight parts of triethyl amine and 0.5 weight parts of poly maleic acid were mixed and dispersed in a pot mill to obtain a material (slurry) for the upper layer 19A.

(Shaping)

121 pins 15b were provided on the bottom face of a metal mold having an outer diameter φ of 480 mm and a height of 5 mm in intervals of 30 mm vertically and horizontally. Each pin had a dimension adjusted for providing a small hole having a predetermined diameter after the sintering process. The slurry for the lower layer was flown into the mold so that the thickness is made 2 mm after the sintering (17 shown in FIG. 1(b): the viscosity was 6 poise measured by a viscometer). The slurry for the upper layer was flown into the mold so that the thickness is made 2 mm after the sintering (19 shown in FIG. 3(c): the viscosity was 6 poise measured by a viscometer). The gel was solidified for about 2 hours to obtain a molded body.

The thus obtained molded body was removed from the metal mold 15 and dried in air for one day. The thus obtained molded body was removed from the mold, heat treated at 250° C. for 5 hours to remove the solvent, dewaxed at 1000° C. for 2 hours, and sintered at 1600° C. for 6 hours to obtain a ceramic member 4. The hole 20A had a diameter φ of 0.5 mm.

(Measurement of Particles)

Each of the samples 1 to 14 was set in a system for testing corrosion with the YAG film orientating downwardly. A spacer with a diameter of 10 mm and an 8-inch Si wafer were set under the sintered body in this order. BCl₃ gas was supplied to a space over the wafer through the holes 20A from the side of alumina containing zirconia. The flow rate of BCl₃ gas was 75 sccm and the flow rate of the carrier gas (argon gas) was 100 sccm. The pressure of the gas was 0.1 torr. RF of 800 W was supplied. The gases were passes through small holes for 5 minutes at 200° C. “SP-1” supplied by Tencor Inc. was used to count the number of particles on the wafer, so that the numbers of particles before and after the corrosion test were compared with each other. The results were shown table 2.

TABLE 2

| | | | | | incidence of |
|---|---|---|---|---|---|
| Experi | first layer | | Second layer | | particles |
| Mental | | Method for | | Method of | (counts/ |
| No | Material | Forming holes | Material | Production | 8 inch wafer) |
| 1 | Alumina | Processing after | — | — | 2800 |
| | | Sintering | | | |
| 2 | YAG | Processing after | — | — | 560 |
| | | Sintering | | | |
| 3 | YSZ | Processing after | — | — | 960 |
| | | Sintering | | | |
| 4 | AlN | Processing after | — | — | 1100 |
| | | Sintering | | | |
| 5 | Si3N4 | Processing after | — | — | 660 |
| | | Sintering | | | |
| 6 | SiC | Processing after | — | — | 940 |
| | | Sintering | | | |
| 7 | Alumina | Gel cast molding | — | — | 880 |
| 8 | YAG | Gel cast molding | — | — | 80 |
| 9 | YSZ | Gel cast molding | — | — | 220 |
| 10 | AlN | Gel cast molding | — | — | 380 |
| 11 | Si3N4 | Gel cast molding | — | — | 160 |
| 12 | SiC | Gel cast molding | — | — | 260 |
| 13 | Alumina | Gel cast molding | YAG | Gel cast | 140 |
| | | | | molding | |
| 14 | Alumina + | Gel cast molding | YAG | Gel cast | 80 |
| | YSZ | | | molding | |

In the comparative samples 1 to 6, the holes were formed in the sintered body by mechanical processing. The number of generated particles was proved to be relatively high. In the inventive samples 7 to 12, the holes were formed by gal cast molding, and it was proved that the number of generated particles was considerably reduced. Further, a time and cost required for production of the ceramic member was also considerably reduced.

In the samples 13 and 14 of the present invention, two kinds of ceramics were used for constituting the ceramic member. It was thus proved that the number of generated particles was also considerably reduced. Further, a time and cost required for production of the ceramic member were also considerably reduced.

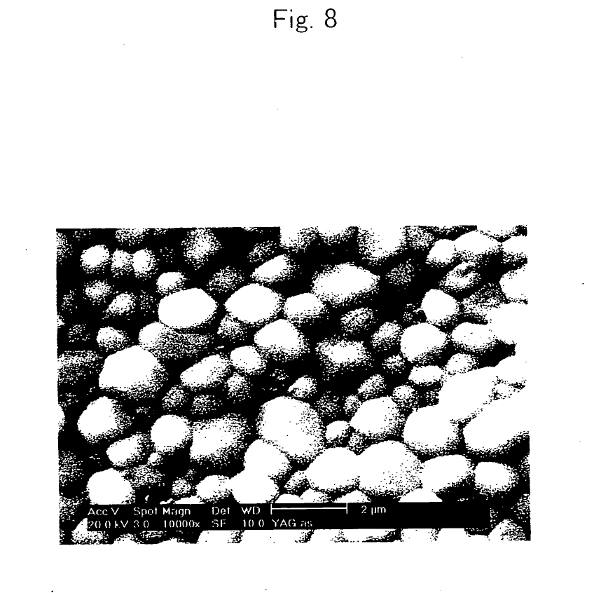

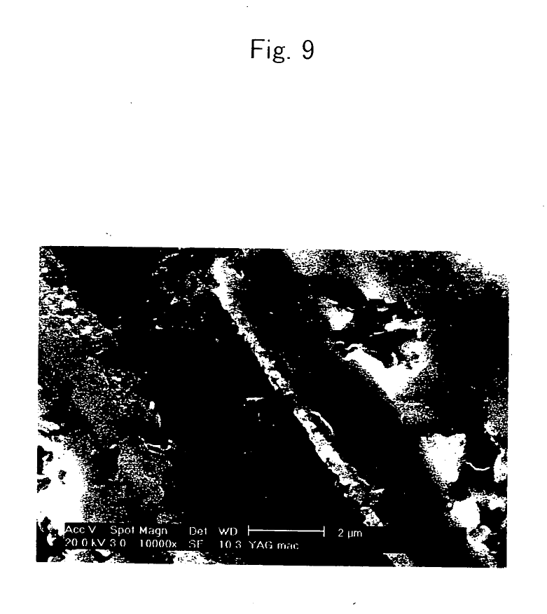

Further, FIG. 8 is a photograph taken by a scanning electron microscope showing an inner wall surface facing the hole in the sample 14 in table 2 (at a magnitude of 10, 000). It is clearly observed that spherical particles are protruded to the surface and recesses are formed corresponding to the intergranular regions between the spherical particles. FIG. 9 is a photograph showing an inner wall surface facing the hole taken by a scanning electron microscope (at a magnitude of 10, 000) of the sample 2 in table 2. In the photograph, the spherical particles are ground and made flat so that the above recesses corresponding to the intergranular regions are not easily distinguishable. It is further observed that polishing damages run in directions inclined to vertical and horizontal axes in the photograph.

As described above, according to the present invention, it is possible to prevent the generation of particles from a hole formed in a ceramic member.

Further, according to the present invention, it is possible to provide a ceramic member with a hole formed therein, so that the production cost is reduced and the dimensional precision is improved compared with a convensional process of forming a hole in a ceramic sintered body.

The present invention has been explained referring to the preferred embodiments, however, the present invention is not limited to the illustrated embodiments which are given by way of examples only, and may be carried out in various modes without departing from the scope of the invention.

1. A ceramic member comprising a hole formed therein: wherein said hole has a diameter in a range of 0.05 mm to 2 mm and a length of 2 mm or more, said member comprises an inner wall surface facing said hole and said inner wall surface comprises an as-sintered face.

2. The ceramic member of claim 1, comprising a plurality of ceramic phases.

3. The ceramic member of claim 2, wherein said ceramic phases comprise at least alumina and yttrium-aluminum garnet phases.

4. The ceramic member of claim 1, comprising a gas distribution plate for use in an etching chamber.

5. A corrosion resistant member comprising a main body made of a ceramics and having a hole formed therein and an innermost layer provided on the inner wall face of said main body and facing said hole, wherein said innermost layer comprises an anti-corrosive ceramics and said hole has a diameter in a range of 0.1 mm to 2 mm and a length of 2 mm or more.

6. The member of claim 5, wherein said innermost layer has a thickness of not smaller than 1 μm and not larger than 2 mm.

7. The member of claim 5, wherein said innermost layer comprises an yttrium-aluminum garnet, said member comprises a portion adjacent to said innermost layer, and said adjacent portion contains alumina in an amount of 50 weight percent or more.

8. A method of producing a ceramic member comprising a hole formed therein, wherein a mold having an outer frame defining a shaping space and a protrusion protruding into said space is used: the method comprising the steps of;
casting a slurry containing an inorganic sinterable powder, a dispersing medium and a gelling agent into said space;
solidifying said slurry by gelation to shape at least a part of a molded body; and
sintering said molded body to provide a ceramic member.

9. The method of claim 8, wherein said ceramic member comprises a plurality of ceramic phases and at least one of said ceramic phases is molded by the gelation of said slurry.

10. The method of claim 9, further comprising the steps of:
casting another slurry containing an inorganic sinterable powder, a dispersing medium and a gelling agent into said space; and
solidifying said slurry by gelation to shape the other of said ceramic phases.

11. The method of claim 8, wherein said dispersing agent is an organic dispersing medium having a reactive functional group, and said organic dispersing medium and said gelling agent are chemically bonded with each other so that said slurry is solidified.

12. The method of claim 11, wherein said organic dispersing medium has the two or more reactive functional groups.

13. The method of claim 11, wherein said organic dispersing medium is an ester, and said gelling agent is a compound having an isocyanate group and/or an isothiocyanate group.

14. The method of claim 8, wherein at least a part of said ceramic member comprises alumina, zirconia, yttria, aluminum nitride, silicon nitride, silicon carbide, the compounds thereof, or the mixture thereof.

15. The method of claim 9, wherein at least one of said ceramic phases comprises a ceramics containing alumina, and the other phase comprises a ceramics containing yttria-alumina composite oxide phase.

16. A method of producing a ceramic member comprising a main body having a hole formed therein and an innermost layer provided on the inner wall face of the member and facing said hole, wherein a mold having an outer frame defining a shaping space and a protrusion protruding into said space is used: the method comprising the steps of;
applying a first gel cast slurry generating said innermost layer upon sintering on said protrusion to solidify said first gel cast slurry;
casting a second gel cast slurry generating said main body upon sintering into said space to solidify said second gel cast slurry so that a molded body is obtained; and
sintering said molded body to provide a ceramic member comprising said main body and said innermost layer.

17. The method of claim 16, wherein said innermost layer comprises a corrosive ceramics, said hole has a diameter in a range of 0.1 mm to 2 mm, and said hole has a length of 2 mm or more.

18. The method of claim 16, wherein said innermost layer has a thickness of not smaller than 1 micrometer and not larger than 2 mm.

19. The member of claim 16, wherein said innermost layer comprises an yttrium-aluminum garnet, said member comprises a portion adjacent to said innermost layer, and said adjacent portion contains alumina in an amount of 50 weight percent or more.
